(19) United States
(12) Patent Application Publication
(10) Pub. No.: US 2011/0054977 A1
(43) Pub. Date: Mar. 3, 2011

(54) CUSTOMER RELATIONSHIP MANAGEMENT USING TEXT MESSAGES

(75) Inventor: Akbar Jaffer, Union City, CA (US)

(73) Assignee: Oracle International Corporation, Redwood Shores, CA (US)

(21) Appl. No.: 12/548,780

(22) Filed: Aug. 27, 2009

(51) Int. Cl. G06F 17/30; H04L 9/32; G06Q 10/00; G06F 17/20; G06N 5/02

(52) U.S. Cl. 705/9; 713/170; 706/11; 707/E17.014; 706/50

(57) ABSTRACT

A method is disclosed. The method includes, responsive to receiving a request for support, building a session profile from the request for support. The request for support is received from a mobile device. The method also includes identifying a solution by querying a database. The querying uses the session profile and the request for support. The database comprises a plurality of possible user inquiries, and a plurality of possible solutions associated with one or more of the plurality of possible user inquiries. The solution is associated with the request for support, and the solution is one of the plurality of possible solutions. The method further includes transmitting the solution to the mobile device. The transmitting includes transmitting a credential to the mobile device, verifying an eligibility of the mobile device, and transmitting the solution and program instructions executable on the mobile device.

### BACKGROUND

Client relationship management (CRM) interfaces are becoming increasingly sophisticated in their ability to allow access to numerous types of application data and/or application systems across multiple forms of communication. For example, a typical customer service application may include an agent interface to allow a customer service agent to navigate among a variety of types of data related to a customer and to products. Such product data may include a knowledge base or other database of product information, while customer data may include contact information, service request information, order information, activity information, and so on. A customer service agent interacting with a customer may be able to navigate quickly all of these types of information during, for example, the course of a single telephone conversation.

Unfortunately, the wealth of available data accessible within a CRM system is frequently unavailable to meet the needs of customers who lack access to reliable, high-bandwidth communication channels in a context where those channels are conveniently accessible. Thus, mobile users face frequent obstacles in their quest to access support provided through CRM systems. Mobile users may not be able to devote the attention necessary to support a sustained voice conversation or may be operating in an environment plagued by noise that renders a voice conversation unintelligible. Such users may also be subject to intermittent connection stability issues that render them unable to carry on a conversation or enjoy the sustained access to bandwidth necessary to operate a web-based CRM customer interface. When access to support from a CRM system and the agents who use the CRM system is unavailable to the mobile user, the tremendous investment made by organization that deployed and depends on the CRM system is rendered temporarily ineffective.

### SUMMARY

A method is disclosed. The method includes, responsive to receiving a request for support, building a session profile from the request for support. The request for support is received from a mobile device. The method also includes identifying a solution by querying a database. The querying uses the session profile and the request for support. The database comprises a plurality of possible user inquiries, and a plurality of possible solutions associated with one or more of the plurality of possible user inquiries. The solution is associated with the request for support, and the solution is one of the plurality of possible solutions. The method further includes transmitting the solution to the mobile device. The transmitting includes transmitting a credential to the mobile device, verifying an eligibility of the mobile device, and transmitting the solution and program instructions executable on the mobile device.

### BRIEF DESCRIPTION OF THE DRAWINGS

The present invention may be better understood, and its numerous objects, features and advantages made apparent to those skilled in the art by referencing the accompanying drawings.

FIG. 1 provides an example of actions taken to support a customer request for support routed to a customer relationship management utility supporting text message-based communication in accordance with one embodiment of the present invention.

FIG. 2 provides an example of a mobile device equipped to implement one embodiment of the present invention.

FIG. 3A is a flowchart describing one embodiment of customer-side client functions for a customer relationship management utility supporting text message-based communication in accordance with the present invention.

FIG. 3B is a flowchart describing one embodiment of a process for receiving and executing code delivered to a mobile device interacting with a customer relationship management utility supporting text message-based communication in accordance with the present invention.

FIG. 4 is a flowchart describing one embodiment of a server process for answering inquiries received via text message for a customer relationship management utility supporting text message-based communication in accordance with the present invention.

FIG. 5 is a flowchart describing one embodiment of process for delivery of executable code used in answering inquiries received via text message for a customer relationship management utility supporting text message-based communication in accordance with the present invention.

FIG. 6 is a flowchart describing one embodiment of an agent-side client for answering inquiries received via text message for a customer relationship management utility supporting text message-based communication in accordance with the present invention.

FIG. 7 is a flowchart describing the interaction between embodiments of a customer-side client on a mobile device, a server process, and an agent-side client used in answering inquiries received via text message for a customer relationship management utility supporting text message-based communication in accordance with the present invention.

FIG. 8 provides an example of an agent interface for a customer relationship management utility supporting text message-based communication in accordance with one embodiment of the present invention.

FIG. 9 is a diagram of a layered architecture in which an embodiment of the present invention can be implemented.

FIG. 10 is a diagram of object layers and object definitions according to the layered architecture of FIG. 10.

FIG. 11 is a block diagram illustrating a computer system suitable for implementing embodiments of the present invention.

The use of the same reference symbols in different drawings indicates similar or identical items. While the invention is susceptible to various modifications and alternative forms, specific embodiments thereof are shown by way of example in the Drawings and are described herein in detail. One skilled in the art will understand, upon having read the present disclosure, however, that the Drawings and Detailed Description are not intended to limit the invention to the particular form disclosed. On the contrary, the intention is to cover all modifications, equivalents, and alternatives falling within the scope of the present invention as defined by the appended Claims.

### DETAILED DESCRIPTION

For a thorough understanding of the subject invention, refer to the following Detailed Description, including the appended Claims, in connection with the above-described Drawings. Although the present invention is described in connection with one or more embodiments, the invention is not intended to be limited to the specific forms set forth herein. On the contrary, the invention is intended to cover such alternatives, modifications, and equivalents as can be reasonably included within the scope of the invention as defined by the appended Claims.

In the following description, for purposes of explanation, numerous specific details are set forth in order to provide a thorough understanding of the invention. One skilled in the art will understand, upon having read the present disclosure, however, that the invention can be practiced without these specific details.

References in the specification to “one embodiment” or “an embodiment” mean that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention addresses several shortcomings of existing techniques. Specifically, one example of an embodiment of the present invention provides for, responsive to receiving a request for support embodied as a text message (e.g., Short Message System (SMS) message) from a mobile device, building a session profile from the request for support. The session profile includes the content of the text message, as well as attributes of a customer, attributes of a service interaction between the customer and an enterprise, and items previously viewed by a customer in an attempt to resolve the request for support. An automated response application queries a database using the session profile. In certain embodiments, the database is a database of possible user inquiries correlated to stored information and code resources potentially applicable to details associated with the session profile. A potential solution associated with the request for support can thus be identified, and subsequently transmitted to the mobile device. The solution is a result of the querying, and transmitting the solution to the mobile device and may further include transmitting a credential to the mobile device, verifying an eligibility of the mobile device, and transmitting program instructions executable on the mobile device.

Additionally, the session profile can be built by iterating interactions with the user of the mobile device (e.g., multiple requests for support, responses, and results). After some number of interactions, the automated interaction with the client can be can be referred to a live agent for human interaction by sending the session profile to the live agent. Thus, the requests for support by some customers will be resolved in an entirely automated fashion. However, the requests of other customers are referred for manual intervention. Using an embodiment of the present invention, by the time that a customer is referred to a live agent, a detailed session profile has been built, containing details known about the customer and the problem, including various results of automated attempts to resolve the user request for support.

The present invention is described with respect to the use of text messages, though only as an example. In one embodiment, SMS messages are used to implement the present invention. As will be clear to one skilled in the art, in light of the present disclosure, the present invention can be practiced with any text-based messaging system, such as SMS on a Global System for Mobile (GSM) network or 3G networks, SkyMail™ from J-Phone™, Short Mail™ and i-mode™ from NTT Docomo™ and a wide range of other protocols such as SMTP over TCP/IP. As will be appreciated, other media can be employed in order to convey the requisite information, including audio media, video media, graphics and other media, as may be efficient and effective for conveying requisite information.

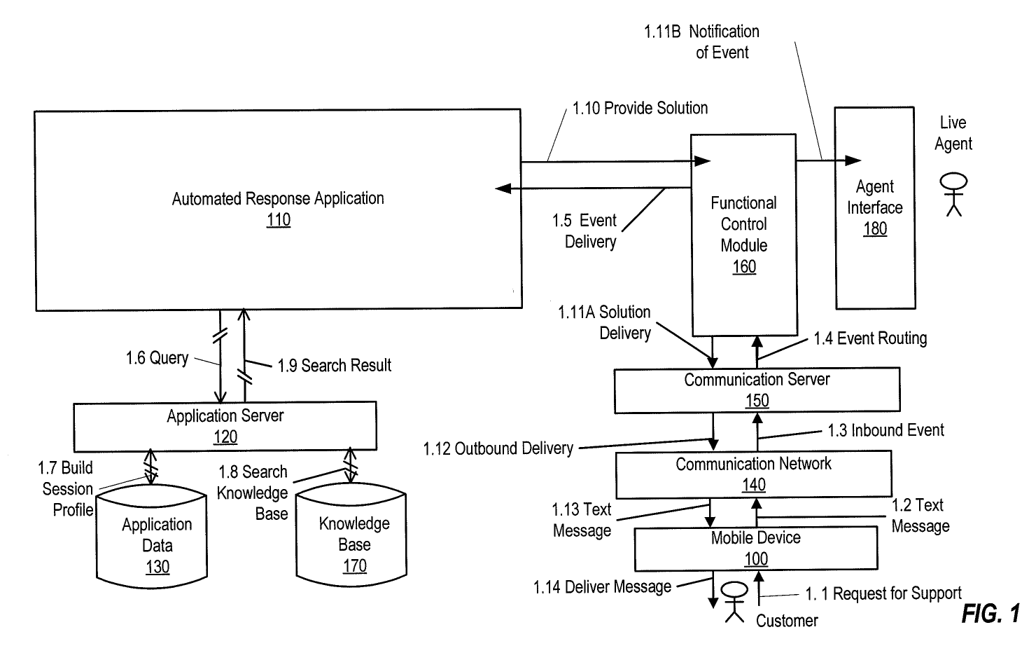

FIG. 1 shows actions taken to support a search utility in response to an incoming communication event in accordance with one embodiment of the present invention. In action 1.1, the customer places a request for support, (e.g., requesting a WEP key), by typing a message into a text interface of a mobile device 100 and instructing mobile device 100 to send the request for support to an address associated with an automated response application 110. A request for customer support may come in the form of a cryptic or not particularly detailed message, intelligible context for which is provided by an application server 120 through the construction of a session profile, which will typically include any known information about the customer or other information surrounding the request, such as the application that is the subject of the request, including data gathered from application data 130, as well as strings resulting from text messages received from mobile device 100 and any results of previous interaction with mobile device 100.

The request for support provided to mobile device 100 is then transmitted by mobile device 100 to a communication network 140 as a text message in action 1.2. Elements of communication network 140 repackage the text message and send an inbound event, via a series of intermediate network devices (not shown) to communication server 150 in action 1.3. Communication server 150 receives the inbound event of action 1.3 and provides an event routing in action 1.4 to a functional control module 160. As will be appreciated, intermediate software modules may be employed between communication server 150 and functional control module 160. In action 1.5, functional control module 160 performs an event delivery to automated response application 110 for processing of the request for support and generation of a solution.

Upon receipt of the event routing delivered in action 1.5, automated response application 110 sends, in action 1.6, a query to application server 120. The query sent in action 1.6 includes the text of the text message sent in action 1.2, as well as any identifying information transmitted with the text message (usually identifying both source and destination, as well as in some embodiments identifying a physical location of mobile device 100). In action 1.7, application server 120 uses information received in the query of action 1.6 to build or retrieve a session profile from data in application data 130. A session profile is retrieved if a session is re-initiated in response to receiving a second request for support from a mobile device. Application data 130 includes a subscriber database. The session profile includes some or all of the content of the text message, content of previous communications to and from the mobile device, as well as attributes of a customer associated with mobile device 100, attributes of mobile device 100, attributes of a service interaction between the customer and an enterprise employing application data 130, and items previously viewed by a customer in an attempt to resolve the request for support. Each session profile is also logged as an activity to a service request. The session profile is built by creating a data structure containing the content of the text message, querying databases to retrieve data that may contain other relevant content (e.g., content of previous communications to and from the mobile device, as well as attributes of a customer associated with mobile device 100, attributes of mobile device 100, attributes of a service interaction between the customer and an enterprise employing application data 130, and items previously viewed by a customer in an attempt to resolve the request for support) and adding to any retrieved relevant content to the session profile data structure.

Once the session profile is built, application server 120 performs action 1.8 by searching a knowledge base 170 using a query based on the content of the session profile constructed in action 1.7. Knowledge base 170 includes, in some embodiments, a closed database of possible user inquiries coupled to executable code resources and responsive text believed to be possibly applicable to the query. Such a closed database is referred to as a closed knowledge base. In alternative embodiments, knowledge base 170 includes a portal for extrinsic searches of the Internet and other resources that are outside of knowledge base 170. Data from such extrinsic searches is referred to extrinsic data, which may be added to a session profile. Such an open database is referred to as an open knowledge base, and a solution may be customized by automated response application 110 in response to receiving extrinsic data. Further, extrinsic data may include network data, such as a communication network data indicating or reflecting the status of a mobile device and customer information data received from third-party customer information database vendors.

In action 1.9, application server 120 sends a search result to automated response application 110. The search result includes both the session profile and possibly appropriate responses from knowledge base 170. Using one embodiment of the present invention, a search of stored information and code resources based on a session profile including attributes of a customer, attributes of a service interaction between the customer and an enterprise, and items viewed by a customer, is also automatically triggered by some communication events or by a search request from an agent, for example, using agent interface 180, and search results (and their display) are configurably tuned on the basis of items previously viewed by the customer and the agent. Content of the session profile influences results received by mobile device 100 in that the search logic will tune results base on session profile content. In one embodiment, in a search for “security patch” in which the session profile indicates that the mobile device 100 is running a given operating system, security patch solutions will be excluded if they are not applicable to the current operating system of mobile device 100. In an alternative embodiment, in a search for “custom wheels” in which the session profile indicates that the user of mobile device 100 owns a particular model of car, only solutions pointed to selling products for the indicated model of car will be returned as query results.

Automated response application 110 contains code embodying a response engine protocol. The response engine protocol contains instructions for selecting an appropriate response (from the search result delivered in action 1.9) to a received query. In some embodiments, automated response application 110 is configured to adjust the response engine protocol parameters by performing multivariate testing of responses (where there exist multiple possible solutions to a support request received from multiple users) to similar queries over time and preferentially sending responses that exhibit higher success rates when provided as solutions.

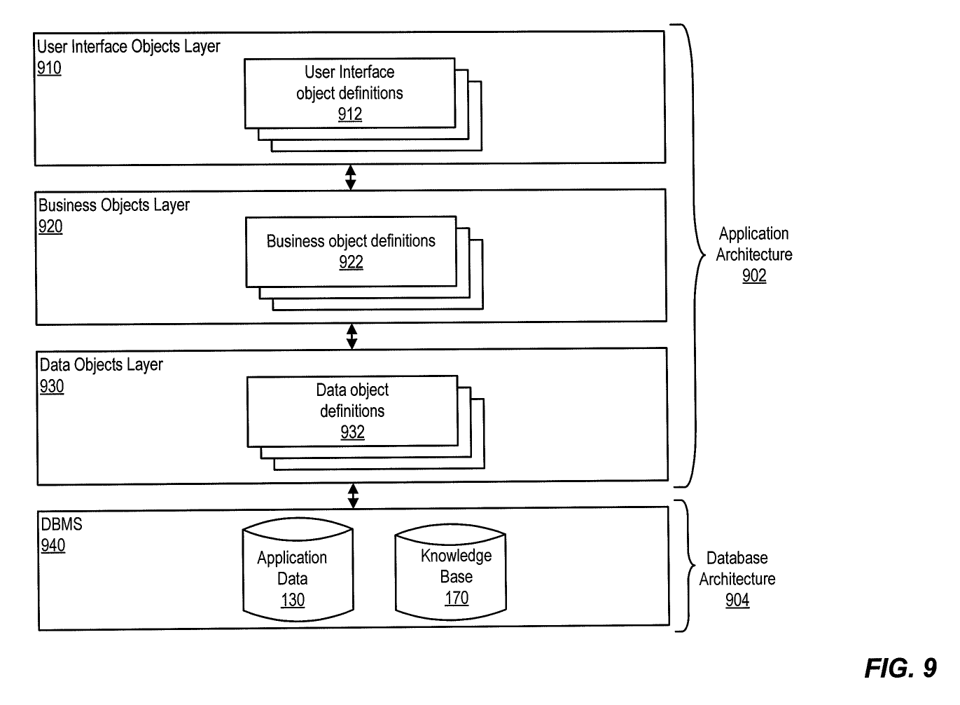

Automated response application 110 provides a solution for delivery to the customer by providing the solution to functional control module 160 in action 1.10. The solution provided includes explanatory text, and, in some embodiments, code to be executed on mobile device 100. Examples of code to be sent as part of a solution vary from patches for code already present on mobile device 100 (such as an operating system patch) to independent applications (such as a database input widget to enable a user submit an order for products). In action 1.11A, functional control module 110 performs a solution delivery to communication server 150. In action 1.11B, notification of an event is provided to a live (human) agent through an agent interface 180, discussed below with respect to FIG. 9. Such a notification of a live agent can be triggered by a keyword string (e.g., “buy new hardware”) in the text message sent in action 1.2 and stored in the session profile during action 1.7, or such a notification of a live agent can be triggered by results in the search result sent in action 1.9 that indicate the need for live agent intervention to resolve a particular problem (such as a failure to find a proposed solution or having exceeded a configurable maximum number of attempts). Automated response application 110 then provides notification of the communication event to the customer service agent, for example, by causing a button on a communication toolbar to blink (as discussed with respect to FIG. 9, below).

In action 1.12, communication server 150 performs outbound delivery as a text message on communication network 140 of the solution delivered in action 1.11B. Communication network 140 then sends the solution as a text message in action 1.13 to mobile device 100. Mobile device 100 delivers the solution as a text message to the customer in action 1.14.

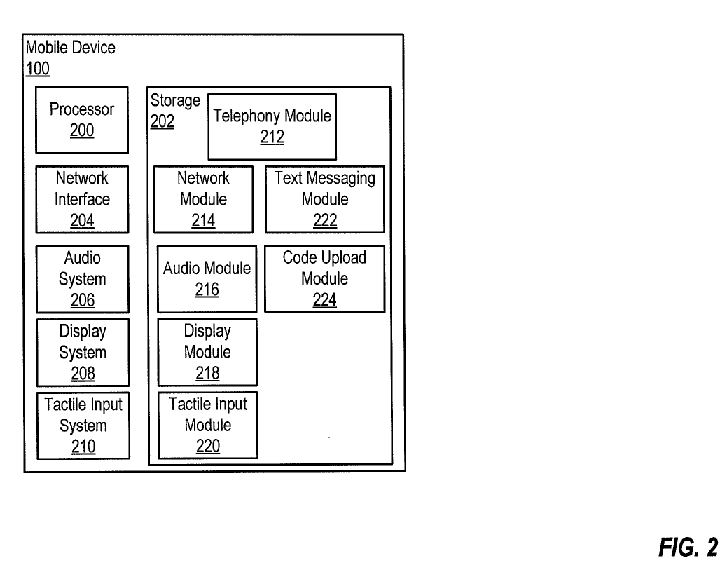

FIG. 2 provides an example of a mobile device equipped to implement one embodiment of the present invention. Mobile device 100 includes a processor 200 and a unit of storage 202, which is embodied as a computer-readable storage medium such as Random Access Memory (RAM). Mobile device 100 further includes a network interface 204 for sending and receiving radio-frequency signals. An audio system 206 includes a microphone, speakers, and audio circuits for audio input to and output from mobile device 100. A display system 208, such as a screen and associated circuits, provides display of visual information to a user of mobile device 100. A tactile input system 210, such as a keypad, allows for a user of mobile device 100 to enter data by touch. In some embodiments of the present invention, tactile input system 210 and display system 208 are combined in a single system and a virtual keypad is displayed on a screen that is touch sensitive.

Within storage 202, software modules 212-224 are stored for execution on processor 200 to execute various functions. Telephony module 212 provides encoding and decoding functions necessary facilitate connection and switching and to convert between received radio frequency signals and audio and video and video input and output. Network module 214 drives network interface 204 in the provision of signaling and radio frequency communication. Audio module 216 drives audio system 206 in the provision of audio input to and output from mobile device 100. Display module 218 drives display system 208 in the provision of visual information to a user of mobile device 100. Tactile input module 220 provides receipt of data from tactile input system 210. Text messaging module 222 provides text-based communication, such as SMS messaging, transmission and receipt of security credentials, and other text-based functions to support the present invention, and code upload module 224 provides for the upload, verification, and execution of executable computer code received in use of the present invention. Software modules 212-224 perform or provide support for various operations executed on mobile device 100 while mobile device 100 is interacting with or being used as part of a customer relationship management utility supporting text message-based communication in accordance with the present invention.

One skilled in the art will, in light of the present disclosure, understand that other software modules, which will vary between embodiments of the present invention, may be used to perform or provide support for various operations executed on mobile device 100 while mobile device 100 is interacting with or being used as part of a customer relationship management utility supporting text message-based communication in accordance with the present invention. Examples of such modules (not shown) include a security module for verifying the identity of solution senders or the integrity of code received as part of a solution. Such a security module can also provide assistance to server-based identity management for providing verification of the eligibility of a given mobile device or a given user for a given solution. Additionally, modules to support particular media (such as fall-motion video) may be included, and uploaded code received as part of a solution can include and install new modules. A decompression module can also be provided, in some embodiments, to facilitate a reduction in network bandwidth demand associated with receipt of some solutions.

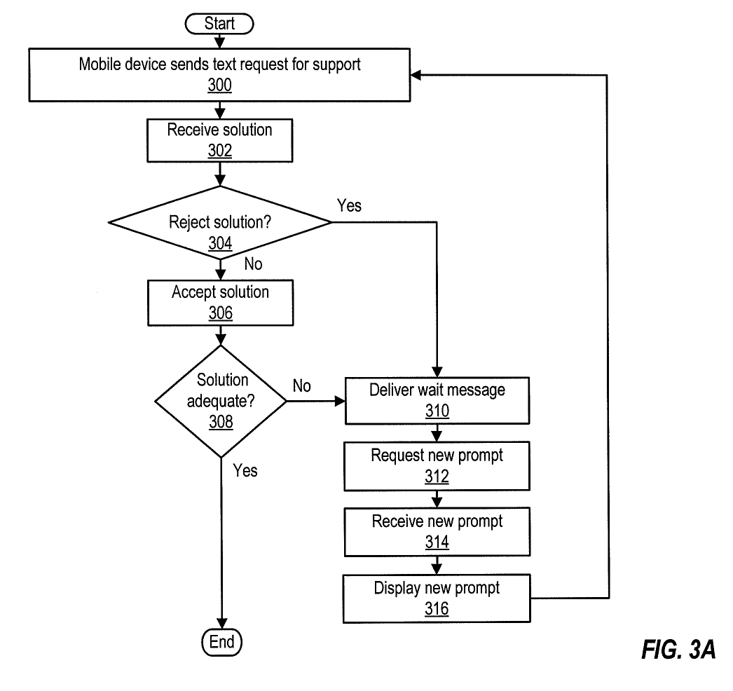

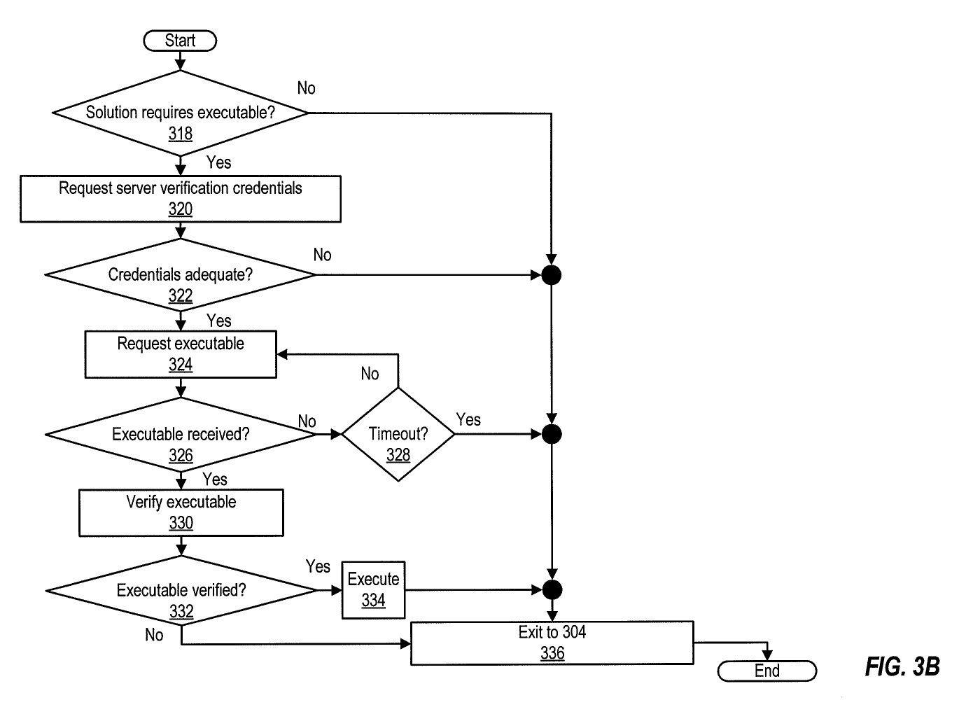

FIG. 3A is a flowchart describing one embodiment of customer-side client functions for a customer relationship management utility supporting text message-based communication in accordance with the present invention. After starting, the process proceeds to step 300, which depicts a mobile device sending a text request for support to an address designated to receive a text request for support. Referring briefly to FIG. 1, action 1.2 is an example embodiment of mobile device 100 sending a text request for support to an address (of automated response application 110) designated to receive a text request for support. The process then proceeds to step 302. Step 302 illustrates receiving a solution. Referring briefly to FIG. 1, action 1.13 is an example embodiment of mobile device 100 receiving a solution. The solution received in step 302 may include text. In some embodiments of the present invention, however, the solution received in step 302 will include executable computer instructions or parameters for performing a download of executable computer instructions.

The process then proceeds to step 304, which depicts a mobile device determining whether to reject the solution received in step 302. Referring briefly to FIG. 2, in some embodiments of the present invention, rejection of a solution is supported, such as by code upload module 224 of FIG. 2, to facilitate user control or mobile device control over whether executable code is downloaded to and executed on the mobile device. For security purposes, some embodiments of the present invention include an automated verification process, such as that described below with respect to FIG. 3B, which can be performed by code upload module 224 of FIG. 2. In alternative embodiments of the invention, the user may be contacted to directly ascertain whether or not a code solution will be accepted. If the solution received in step 302 is rejected in step 304, then the process proceeds to step 310 (discussed below). If the answer received in step 302 is accepted in step 304, then the next moves to step 306.

Step 306 illustrates a mobile device accepting a solution. Examples of solution acceptance will vary from one embodiment of the present invention to the next. In one embodiment of the present invention, a solution can be accepted by opening a text message received on a mobile device in response to a request for support. In more complex implementations of the present invention, accepting a solution may include the execution of code, such as by code upload module 224 of FIG. 2. Alternatively, acceptance can be indicated by the return of a reply text message from a mobile device to an address designated to receive such a reply. This return address can be the address receiving the text request for support generated in step 300, the address sending the solution received in step 302, or another address, for example.

The process then proceeds to step 308, which depicts determining whether the solution received in step 308 is adequate to resolve the request for support sent in step 302. Methods for verifying solution adequacy will vary from embodiment to embodiment. In one embodiment of the present invention, the message received in step 302 will contain instructions informing the user to respond with a reply message indicating “1 for adequate solution” or “2 for failed solution and a retry.” In such an approach, the user is tasked with making a determination as to the adequacy of the solution received. Alternatively, an automated failure notice can be created. In one embodiment, an automated failure message is created by including a checksum with a set of downloaded instructions received by code upload module 224. At the end of deploying code or instructions on mobile device 100, code upload module 224 can perform a calculation on system variables or on the deployed data, and code upload module 224 can then compare the result to the received checksum. If the calculation does not match the checksum, a failure message, similar to a failure message generated in response to a user expression of dissatisfaction, can be generated. Such a failure message, which can contain an expression of dissatisfaction from a user of a mobile device or an automated failure notice, can be sent to an address designated to receive such a reply, which may be the address receiving the text request for support generated in step 300, the address sending the solution received in step 302, or a third address. Referring briefly to FIG. 2, in an alternative embodiment, in which code has been executed as part of the solution, mobile device 100 may, using a software module such as code upload module 224, detect a confirmation checksum and send the confirmation checksum an address designated to receive replies. If the solution is determined to be adequate, the process ends.

If, however, the solution is determined not to be adequate, the process next moves to step 310. Step 310 illustrates a mobile device delivering a wait message. In one embodiment, delivery of a wait message includes displaying a message instructing the user to wait for further instructions. In one embodiment of the present invention, the wait message is the second message received from an automated response application, such as automated response application 110 of FIG. 1. In some embodiments, a wait message contains alternative instructions such as, “reply with a ‘1’ to request a phone call, reply with a ‘2’ to request email to your registered address, or call dial number ‘xyzqr’ to speak to a representative immediately.” The process then proceeds to step 312, which depicts requesting a new prompt from an automated response application, such as automated response application 110 of FIG. 1. In one embodiment of the present invention, a request for a new prompt is embodied as a request for support, which is similar to the request for support sent in action 1.1 of FIG. 1. In another embodiment, a request for a new prompt contains logging information indicating a particular type of failure and providing data for storage in a session profile. In yet another embodiment, a request for a new prompt is automatically generated by a mobile device, such as mobile device 100, and sent to an automated response application, such as automated response application 110 of FIG. 1.

The process next moves to step 314. Step 314 illustrates a mobile device receiving a new prompt. In one embodiment, the new prompt received in step 314 is a new text message containing a new solution. This new solution includes, in one embodiment, new instructions or text from a knowledge base, such as knowledge base 170 of FIG. 1. In an alternative embodiment, the new solution includes new executable code. The process next proceeds to step 316, which depicts display of the new prompt to a user. The process then returns to step 300, which is described above.

FIG. 3B is a flowchart describing one embodiment of a process for receiving and executing code delivered to a mobile device interacting with a customer relationship management utility supporting text message-based communication in accordance with the present invention. After starting, the process proceeds to step 318, which depicts determining whether the solution (received, for example, in step 302 of FIG. 3A) requires executable computing instructions to be downloaded and executed. Note that, in some embodiments of the present invention, the phrase “includes executable computing instructions” does not necessarily mean that executable computing instructions have been transmitted to a mobile device. In some embodiments, solutions that include executable computing instructions will merely contain a hyperlink or other addressing and retrieval information to enable a mobile device to retrieve the executable instructions.

If a determination is made that the solution does not require executable computing instructions to be downloaded and executed, then the process proceeds to step 336. Step 336 illustrates exiting the process, for instance, by returning to step 304 of FIG. 3A. The process then ends. If a determination is made that the solution requires executable computing instructions to be downloaded and executed, then the process next moves to step 320, which depicts requesting server verification credentials. In one embodiment of the present invention, in order to limit access to mobile device 100 of FIG. 1 for security purposes, code upload module 224 of FIG. 2 and text messaging module 222 of FIG. 2 send a request to automated response application 110 of FIG. 1 to provide a security key, which is a prime number that is used as part of a public-key identity verification system. Other embodiments of the invention will use alternative credentialing schemes, such as time-based algorithms.

The process then proceeds to step 322. Step 322 illustrates determining whether the credentials requested in step 320 are (received, inspected, and determined to be) adequate. If a determination is made that the credentials requested in step 320 are not adequate, then the process proceeds to step 336, which is described above. If a determination is made that the credentials requested in step 320 are adequate, then the process proceeds to step 324, which depicts request of an executable file containing instructions for execution on the mobile device. In one embodiment of the present invention, after verifying the credentials of automated response application 110 of FIG. 1 for security purposes, code upload module 224 of FIG. 2 and text messaging module 222 of FIG. 2 send a request to automated response application 110 of FIG. 1 to provide an executable file containing instructions for execution on the mobile device.

The process next moves to step 326. Step 326 illustrates determining whether the executable requested in step 324 has been received. If the executable has not been received, the process next moves to step 328, which depicts determining whether a receipt timeout has expired. If the timeout has not expired, the process returns to step 324, which is described above, for an iteration of the request for the executable. If the timeout has expired, the process next moves to step 336, which is described above. Returning to step 326, if a determination is made that the executable requested in step 324 has been received, the process next moves to step 330. Step 330 depicts verifying the executable. In one embodiment of the verification depicted in step 330, code upload module 224 decompresses the received executable and calculates a checksum authentication value for each of the files received. The checksum is then compared to a reference value associated with the executable.

The process then proceeds then proceeds to step 332, which depicts determining whether the executable received in step 324 was successfully verified. If a determination is made that the executable was successfully verified, then the executable executes at step 334. The process then proceeds to step 336, which is described above. Returning to step 332, if a determination is made that the executable was not successfully verified, then the process then proceeds to step 336, which is described above.

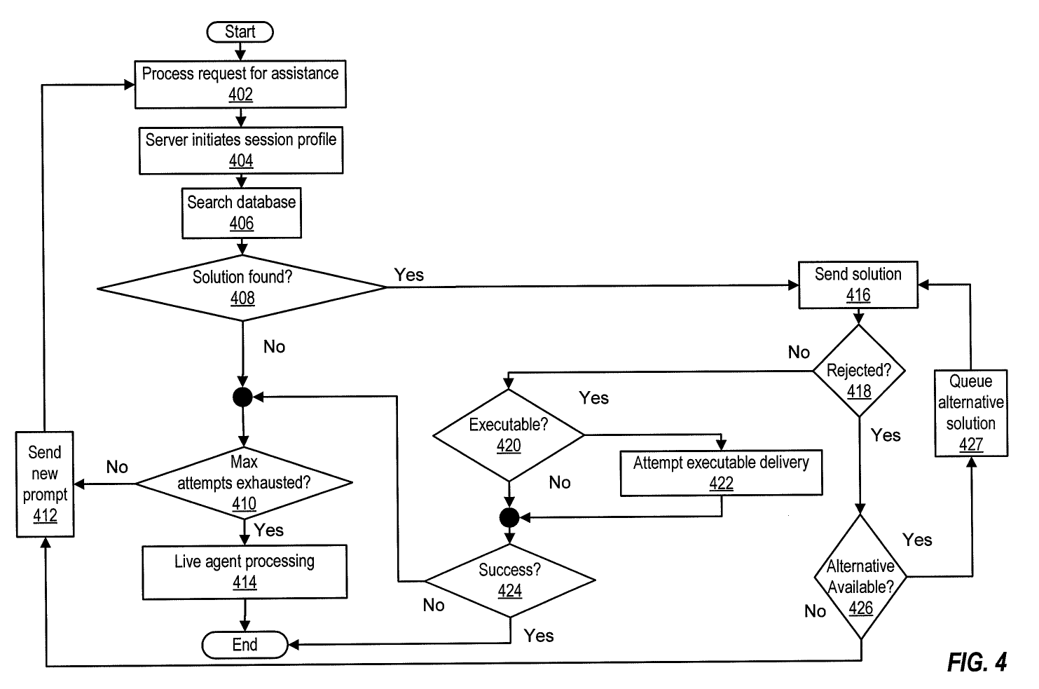

FIG. 4 is a flowchart describing one embodiment of a server process for answering inquiries received via text message for a customer relationship management utility supporting text message-based communication in accordance with the present invention. The process begins with a server processing a request for support at step 402. Referring briefly to FIG. 1, an example of a server processing a request for support is portrayed in action 1.5, in which functional control module 160 performs an event delivery to automated response application 110 for response. The process next moves to step 404. Step 404 illustrates a server initiating (or updating) a session profile. Referring briefly to FIG. 1, an example of a server initiating a session profile is portrayed in action 1.7, in which application server 120 uses information received in the query of action 1.6 to build (or retrieve) a session profile from data in application data 130.

The process next moves to step 406. Step 406 illustrates a server searching a database to generate a solution. Referring briefly to FIG. 1, an example of a server searching a database for a solution is portrayed in action 1.8, in which application server 120 performs a knowledge base search based on the content of the session profile constructed in action 1.7. The process then proceeds to step 408, which depicts a server determining whether an appropriate solution to the request for support has been found. If a determination is made that a solution has not been found, then the process proceeds to step 410. Step 410 depicts determining whether a threshold for a maximum number of attempts has been exhausted. Such a threshold is automatically configurable based on the content of a session profile. If a determination is made that a maximum number of solution attempts has not been exhausted, the process proceeds to step 412, which depicts sending a new prompt. This new prompt includes, in one embodiment of the present invention, new solution instructions or text from a knowledge base, such as knowledge base 170 of FIG. 1. Such new text or solution instructions can include a request for more information on the nature of the request for support or instructions on finding further information necessary for a solution. In an alternative embodiment, the new prompt includes new executable code. The process then returns to step 402, which is described above.

Returning to step 410, if a determination is made that a maximum number of solution attempts has been exhausted, the process proceeds to step 414. Step 414 depicts queuing of the session profile for live agent processing. Referring briefly to FIG. 1, in action 1.11B, an example of sending a notification of an event to a live agent is portrayed. The notification of event mechanism of action 1.11B can also be used to queue a session profile for live agent processing. An exemplary interface for live agent processing is discussed below with respect to FIG. 9. The process then ends.

Returning to step 408, if a determination is made that an appropriate solution has been found, then the process proceeds to step 416. Step 416 illustrates sending the currently queued solution. An example of sending a solution is portrayed in FIG. 1 by automated response application 110 providing a solution for delivery to the customer by sending the solution to functional control module 160 in action 1.10. The solution provided can include explanatory text, and, in some embodiments, code that can be executed on mobile device 100. The process then proceeds to step 418. Step 418 illustrates determining whether the solution sent in step 416 was rejected. In some embodiments of the present invention, rejection of answer is supported, such as by code upload module 224 of FIG. 2, to facilitate user and/or mobile device control over whether executable code is downloaded to and executed on the mobile device.

If the solution sent in step 418 is not rejected, the process proceeds to step 420, which depicts a determination as to whether the solution sent step 416 requires delivery of an executable to a mobile device. If a determination is made that the solution sent step 416 requires delivery of an executable to a mobile device, the process then proceeds to step 422. Step 422 depicts attempting executable delivery. The process then moves to step 424, which illustrates determining whether the solution sent in step 416 was successful. If the solution sent in step 416 was successful, then the process ends. If the solution sent step 416 was not successful, then the process returns to step 410, which is described above.

Returning to step 420, if a determination is made that the solution sent step 416 does not require delivery of an executable to a mobile device, the process then proceeds to step 424, which is described above.

Returning to step 418, if the solution sent in step 418 is rejected, the process next proceeds to step 426, which depicts determining whether an alternative solution is available. If a determination is made that an alternative solution is available, then the process proceeds to step 427, which depicts the queuing of an alternative solution to be sent to the mobile device. The process then returns to step 416, which is described above. If a determination is made that no alternative solution is available, then the process proceeds to step 412, which is described above.

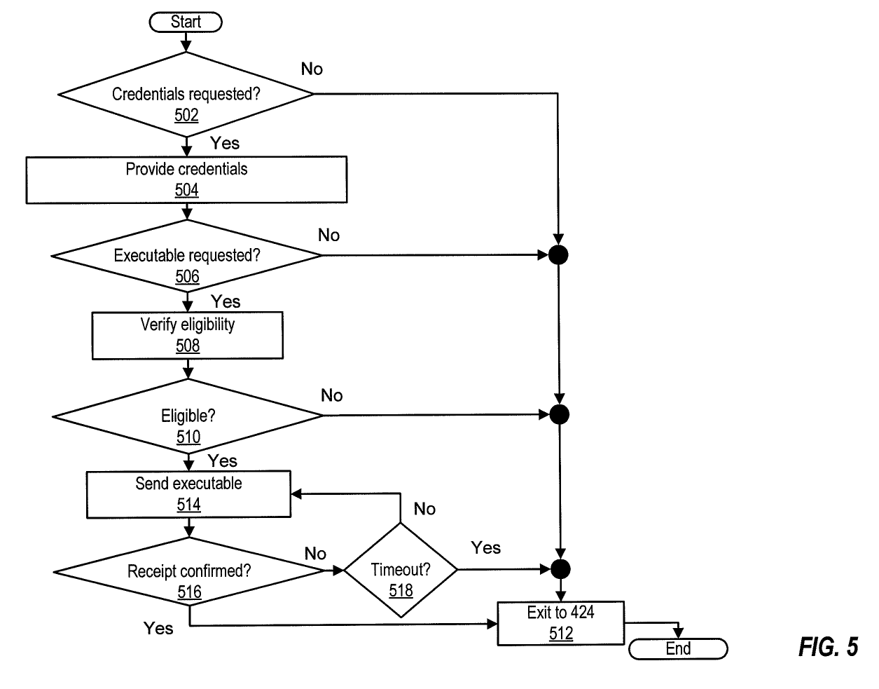

FIG. 5 is a flowchart describing one embodiment of a process for delivery of executable code used in answering inquiries received via text message for a customer relationship management utility supporting text message-based communication in accordance with the present invention. After starting, the process moves to step 502. Step 502 illustrates determining whether a mobile device has requested credentials from a server. In one embodiment of the present invention, in order to limit access to mobile device 100 of FIG. 1 for security purposes, code upload module 224 of FIG. 2 and text messaging module 222 of FIG. 2 send a request to automated response application 110 of FIG. 1 to provide a security key, which is a prime number that is used as part of a public-key identity verification system. In one embodiment of the present invention, step 502 allows for detection of whether such a request has been received. If a request for credentials has not been received after a configurable length of time, then the process moves to step 512. Step 512 depicts exiting the process of FIG. 5 to step 424 of FIG. 4. The process then ends.

Returning to step 502, if a request for credentials has been received, then the process moves to step 504, which depicts providing credentials, such as, in one embodiment, a security key that is a prime number that is used as part of a public-key identity verification system. The process next moves to step 506. Step 506 illustrates determining whether a mobile device has requested delivery of an executable. If a request for an executable has not been received after a configurable length of time, then the process moves to step 512, which is described above. If a request for an executable has been received, then the process moves to step 508. Step 508 illustrates a server verifying the eligibility of a mobile device requesting an executable to receive the executable. Referring briefly to FIG. 1, such eligibility may be verified requesting comparison of the identity of the device to a list of supported devices and device permissions stored in a subscriber database that is a portion of application data 130.

The process then proceeds to step 510, which depicts determining whether the mobile device that has requested an executable is eligible to receive the executable. If the mobile device that has requested the executable is not eligible to receive the executable, the process next moves to step 512, which is discussed above. If the mobile device that has requested the executable is eligible to receive the executable, the process next moves to step 514, which depicts sending the executable to the mobile device. The process next proceeds to step 516. Step 516 illustrates determining whether a receipt the executable sent in step 514 has been confirmed. If a determination is made that receipt of the executable sent in step 514 has been confirmed, then the process proceeds to step 512, which is described above. If a determination is made that the receipt of the executable has not been confirmed, then the process proceeds to 518. Step 518 depicts determining whether a time limit for confirmation of receipt (a timeout) has been exceeded. If a determination is made that the time limit for confirmation of receipt has been exceeded, then the process proceeds to step 512, which is described above. If a determination is made that the time limit for confirmation of receipt has not been exceeded, then the process returns to step 514, which is described above, for resending of the executable.

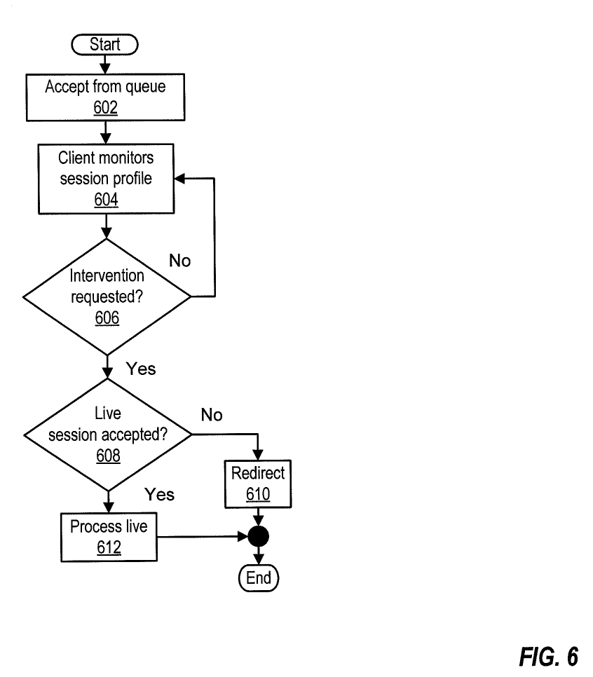

FIG. 6 is a flowchart describing one embodiment of an agent-side client for answering inquiries received via text message for a customer relationship management utility supporting text message-based communication in accordance with the present invention. After starting, the process proceeds to step 602, which depicts an agent interface client, such as the agent interface client discussed below with respect to FIG. 9, accepting a session profile from a queue of session profiles selected for monitoring. Referring briefly to FIG. 1, such a notification to a live agent can be queued as a result of a keyword string (e.g., buy new hardware) in the text message section of the session profile, or such a notification to a live agent can be triggered by results in the search result sent in action 1.9 that indicate the need for live agent intervention to resolve a particular problem (such as a failure to find a proposed solution or having exceeded a maximum number of attempts). Automated response application 110 then provides notification of the communication event to the customer service agent, for example, by causing a button on communication toolbar of a client application, discussed with respect to FIG. 9, below, to blink.

The process next moves to step 604. Step 604 illustrates a client monitoring a session profile. Updates to the session profile, including communications between a mobile device and an automated response application, are delivered to the client. The process then proceeds to step 606, which depicts a determination as to whether a user of the client (an agent) has requested intervention in the session represented by the session profile. If a determination is made that the agent has not requested intervention in the session profile, then the process returns to step 604, which is described above. If a determination is made that the agent has requested intervention in the session profile, then the process proceeds to step 608. Step 608 illustrates a determination as to whether the agent will engage in a live session. If a determination is made that the agent will not engage in a live session, the process moves to step 610, which depicts a redirect process, such as sending an agent-corrected query to an automated response application. The process then ends. If, however a determination is made at step 608 that the agent has accepted a live session, the process proceeds to step 612, which depicts live processing interaction between the customer and the agent. Upon completion of the live processing, the process then ends.

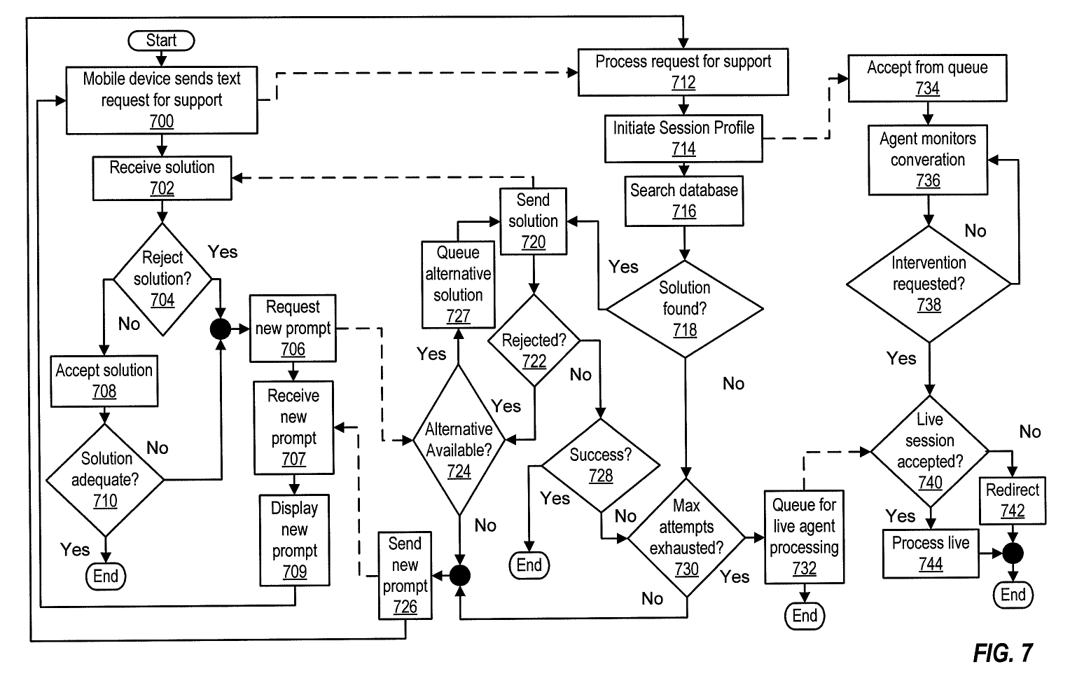

FIG. 7 is a flowchart describing the interaction between embodiments of a customer-side client on a mobile device, a server process, and an agent-side client used in answering inquiries received via text message for a customer relationship management utility supporting text message-based communication in accordance with the present invention. Initially, the actions performed in FIG. 7 are described, below, with respect to the perspective of a mobile device. Perspective then shifts, in step 712, to that of an automated response application and shifts again, in step 734, to that of an agent interface. Broken lines in FIG. 7 indicate interactions between processes which will, in light of the present disclosure, be well understood by a person having skill in the data processing arts. After starting, the process proceeds to step 700, which depicts a mobile device sending a text request for support to an address designated to receive a text request for support. As depicted in FIG. 1, action 1.2 is an example of a mobile device 100 sending a text request for support to an address (of automated response application 110) designated to receive a text request for support. The request for support of step 702 on mobile device 100 causes, through a series of intermediate events, a server to process the request for support, as described below with respect to step 712.

The process then proceeds to step 702. Step 702 illustrates receiving a solution, such as reception of a solution by mobile device 100. As depicted in FIG. 1, action 1.13 is an example of a mobile device 100 receiving a solution. The solution received in step 702 may include only plain text. In some embodiments of the present invention, however, the solution received in step 702 will include executable computer instructions or parameters for performing a download of executable computer instructions.

The process then proceeds to step 704, which depicts a mobile device determining whether to reject the solution received in step 702. In some embodiments of the present invention, rejection of answer is supported, such as by code upload module 224 of FIG. 2, to facilitate user control and mobile device control over whether executable code is downloaded to and executed on the mobile device. For security purposes, a verification process, such as that described above with respect to FIG. 3B, is sometimes executed, such as by code upload module 224 of FIG. 2, in some embodiments of the present invention. If the solution received in step 702 is rejected in step 704, then the process proceeds to step 706, which is discussed below. If the answer received in step 702 is not rejected in step 704, then the next moves to step 708.

Step 708 illustrates the process of a mobile device accepting a solution. Examples of solution acceptance will vary from embodiment to embodiment of the present invention. In one embodiment of the present invention, a solution can be accepted by opening a text message received on a mobile device in response to a request for support. In more complex implementations of the present invention, accepting a solution may include execution of code, such as by code upload module 224 of FIG. 2, or the return of a reply text message from a mobile device to an address designated to receive such a reply, which may be the address receiving the text request for support generated in step 700, the address sending the solution received in step 702, or a third address.

The process then proceeds to step 710, which depicts determining whether the solution received in step 702 is adequate to resolve the request for support sent in step 700. Methods for verifying solution adequacy will vary from embodiment to embodiment. In one embodiment of the present invention, the message received in step 702 will contain instructions informing the user to respond with a reply message indicating “1 for adequate solution” or “2 for failed solution and a retry.” Such a message can be sent to an address designated to receive such a reply, which may be the address receiving the text request for support generated in step 700, the address sending the solution received in step 702, or a third address. In an alternative embodiment, in which code has been executed as part of the solution, the mobile device may, using a module such as code upload module 224 of FIG. 2, detect a confirmation checksum or send a confirmation checksum to an address designated to receive replies. If the solution is determined to be adequate, the process ends (with respect to the mobile device).

If, however, the solution is determined not to be adequate, the process next moves to step 706, which depicts requesting a new prompt from an automated response application, such as automated response application 110 of FIG. 1. In one embodiment, a request for a new prompt contains logging information indicating a type of failure and providing data for storage in a session profile. In one embodiment, a request for a new prompt is a message automatically generated by a mobile device, such as mobile device 100 and sent to an automated response application, such as automated response application 110 of FIG. 1. Step 706 causes, through a series of intermediate events, a server to seek an alternative solution, as described below with respect to step 724.

The process next move to step 707. Step 707 illustrates a mobile device receiving a new message containing a new prompt. This new prompt includes, in one embodiment, new solution instructions or text from a knowledge base, such as knowledge base 170 of FIG. 1. In an alternative embodiment, the new prompt includes new executable code. The process next moves to step 709, which depicts display of the new prompt to a user. The process then returns to step 700, which is described above.

Turning now to step 712 and describing actions performed from the perspective of an automated response application, after a mobile device sends a request for support in step 700, a series of intermediate events (such as message delivery through intermediate servers) lead to step 712 being performed on an automated response server. Step 712 depicts a server processing a request for support. Referring briefly to FIG. 1, an example of a server processing a request for support is portrayed in action 1.5, in which functional control module 160 performs an event delivery to automated response application 110 for response. The process next moves to step 714. Step 714 illustrates a server initiating or updating a session profile. Referring briefly to FIG. 1, an example of a server initiating or updating a session profile is portrayed in action 1.7, in which application server 120 uses information received in the query of action 1.6 to build or retrieve a session profile from data in application data 130. As will be appreciated, a series of intermediate events (such as message delivery through intermediate servers) may occur, but will eventually lead to step 734 being performed (as described below).

The process next moves to step 716. Step 716 illustrates a server searching a database to generate a solution. Referring briefly to FIG. 1, an example of a server searching a database for a solution is portrayed in action 1.8, in which application server 120 performs a knowledge base search based on the content of the session profile constructed in action 1.7. The process then proceeds to step 718, which depicts a server determining whether a solution to the request for support has been found. If a determination is made that a solution has not been found, then the process proceeds to step 730. Step 730 depicts determining whether a maximum number of attempts has been reached. If a determination is made that a maximum number of solution attempts has not yet been reached, the process proceeds to step 726, which depicts sending a new prompt. This new prompt includes, in one embodiment, new solution instructions or text from a knowledge base, such as knowledge base 170 of FIG. 1. In an alternative embodiment, the new prompt can include new executable code. Step 726, through a series of intermediate events (such as message delivery through intermediate servers), leads to execution of step 707, which is described above. The process then returns to step 712, which is described above.

Returning to step 730, if a determination is made that a maximum number of solution attempts has been exhausted, the process proceeds to step 732. Step 732 depicts queuing of the session profile for live agent processing. Referring briefly to FIG. 1, in action 1.11B, an example of sending a notification of an event to a live agent is portrayed. The notification of event mechanism of action 1.11B can also be used to queue a session profile for live agent processing. An example interface for live agent processing is discussed below with respect to FIG. 9. The process then ends (with respect to automated response server interaction), though step 740, which is described below, is initiated through a series of intermediate events (such as message delivery through intermediate servers).

Returning to step 718, if a determination is made that a solution has been found, then the process proceeds to step 720. Step 720 illustrates sending the currently queued solution. An example of sending a solution is portrayed in FIG. 1 by automated response application 110 providing a solution for delivery to the customer by sending the solution to functional control module 160 in action 1.10. The solution provided can include explanatory text, and, in some embodiments, code that can be executed on mobile device 100. Step 720, through a series of intermediate events (such as message delivery through intermediate servers), leads to step 702, which is described above. The process then proceeds to step 722. Step 722 illustrates determining whether the solution sent in step 720 was rejected. In some embodiments of the present invention, rejection of a solution is supported, such as by code upload module 224 of FIG. 2, to facilitate user control over whether executable code is downloaded to and executed on the mobile device.

If the solution sent in step 720 is not rejected, the process proceeds to step 728, which depicts a determination as to whether the solution sent step 728, which illustrates determining whether the solution sent in step 720 was successful. If the solution sent in step 720 was successful, then the process ends. If the solution sent step 720 was not successful, then the process returns to step 730, which is described above.

Returning to step 722, if the solution sent in step 720 is rejected, the process next proceeds to step 724, which depicts determining whether an alternative solution is available. If a determination is made that an alternative solution is available, then the process next proceeds to step 727, which depicts queuing an alternative solution for delivery. The process then returns to step 720, which is described above. If a determination is made that no alternative solution is available, then the process proceeds to step 726, which is described above.

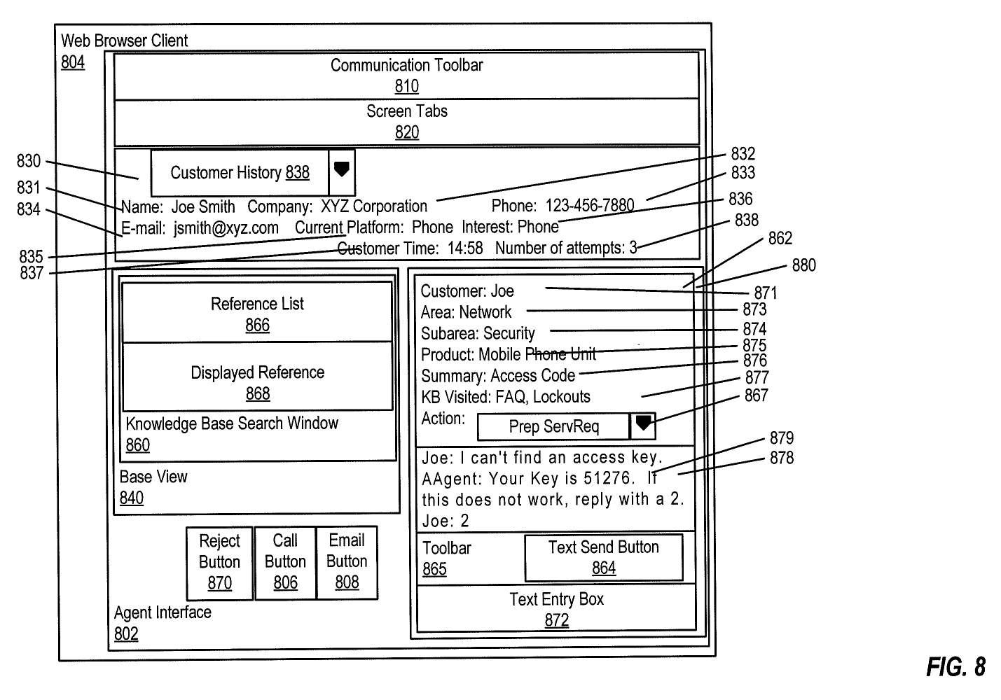

Turning now to step 734 and describing actions performed from the perspective of an agent interface, step 734 depicts an agent interface client, such as the agent interface client discussed below with respect to FIG. 7, accepting a session profile from a queue of session profiles selected for monitoring. Referring briefly to FIG. 1, such a notification of a live agent can be triggered by a keyword string (e.g., “buy new hardware”) in the text message section of the session profile, or such a notification can be triggered by results in the search result sent in action 1.9 that indicate the need for live agent intervention to resolve a particular problem (such as a failure to find a proposed solution or having exceeded a maximum number of attempts). Automated response application 110 then provides notification of the communication event to the customer service agent, for example, by causing a button on communication toolbar of a client application, discussed with respect to FIG. 8, below, to blink.

The process next moves to step 736. Step 736 illustrates a client monitoring a session profile. Updates to the session profile are delivered to the client. The process then proceeds to step 738, which depicts a determination as to whether a user of the client (an agent) has requested intervention in the session represented by the session profile. If a determination is made that the agent has not requested intervention in the session profile, then the process returns to step 736, which is described above. If a determination is made that the agent has requested intervention in the session profile, then the process proceeds to step 740. Step 740 illustrates a determination as to whether the agent will engage in a live session. If a determination is made that the agent will not engage in a live session, the process moves to step 742, which depicts a redirect process, such as sending an agent-corrected query to an automated response application. The process then ends. If, however, a determination is made at step 740 that the agent has accepted a live session, the process proceeds to step 744, which depicts live processing interaction between the customer and the agent. Upon completion of the live processing, the process then ends.

FIG. 8 provides an example of an agent interface for a customer relationship management utility supporting text message-based communication in accordance with one embodiment of the present invention. FIG. 8 shows an agent interface 802 presented for agent use by a web browser client 804. In one embodiment, no client software other than a web browser is needed to run the agent interface for the host application. Agent interface 802 includes a communication toolbar 810, screen tabs 820, a persistent dashboard 830, a text communication window 880 and a base view 840. Base view 840 represents a display window in which application data are displayed, such that the dashboard 830 provides context information related to the application data. Base view 840 contains a knowledge base search window 860. Communication toolbar 810, knowledge base search window 860 and screen tabs 820 are not essential for the operation of a text communication window 880. Knowledge base search window contains a reference list 866 and a displayed reference 868, which are updated based on search results, such as those provided in action 1.9 of FIG. 1.

Communication toolbar 810 enables an agent to communicate via multiple types of communication channels, such as e-mail, telephone, facsimile, text chat and wireless messaging. Communication toolbar 810 enables an agent to navigate between sessions representing multiple users. Screen tabs 820 enable an agent to navigate among various types of application data.

Text communication window 880 supports communication between a customer and an agent through text-based messaging, such as SMS, which can include transmission of messages containing a markup language such as HTML, for example. Text communication window 880 also supports monitoring of communication between a customer and an automated response application, such as automated response application 110 of FIG. 1, through text-based messaging, such as SMS, which can include transmission of messages containing a markup language such as HTML, for example. In some embodiments, text communication window 880 can additionally support delivery of executable files.

A customer information pane 862 provides information mined from a session profile, which is determined to be relevant to a customer interaction, such as a username 871, which may contain any identifier used to communicate with a customer, such as a customer's name, username or handle. An area 873 broadly represents a product or service type of interest to the customer on the basis of the customer's indication of interest in a request for support or on the basis of data previously stored in relation to the customer and available in the session profile. A subarea 874 more narrowly defines the product or service type of interest to the customer on the basis of the customer's indication of interest in a request for support or on the basis of data previously stored in relation to the customer and available in the session profile. A product 875 defines the specific offering of interest to the customer on the basis of the customer's indication of interest in a request for support or on the basis of data previously stored in relation to the customer and available in the session profile. A summary 876 provides a brief description, based on the results of a search of knowledge base 170 and application data 130, of the problem that the customer is trying to solve. KB visited 877 indicates the portions of knowledge base 170 that an automated response server has selected as a potential source for an answer, typically before communicating with a live agent.

An action pulldown menu 867 enables an agent to quickly access actions that may be relevant to the customer's situation, such as preparation of a service request, or access files and standard responses that can be sent over the text communication window 880. A text entry box 872 allows the agent to enter text for transmission to a customer.

A session window 878 displays a record of transmissions between an agent and a customer. In the session window 878, highlighted text can be selected with a mouse, for a cut-and-paste operation or a search operation. An automated response 879 provided in answer to a text message received from a customer, is displayed in session window 878. A toolbar 865 allows for the placement of buttons, such as text send button 864.

In the exemplary embodiment shown in FIG. 8, persistent dashboard 830 includes various data fields such as contact name 831, company 832, phone 833, e-mail 834, current platform 835, interest 836, customer time 837, and number of attempts 838, which displays the number of communication cycles or requests for support have elapsed in the current session profile. Persistent dashboard 830 also includes customer history combo box 838, which enables the agent to view in base view 840 the history of previous communications with the customer whose information is displayed in persistent dashboard 830. This same information is available for use by automated response application 110 in providing responses and selecting solutions, and display to the agent through agent interface 802 allows for an agent using agent interface 802 to appear to “know” the customer and to expeditiously respond to a customer inquiry. Additionally, actuation of a call button 806 causes routing of a call to the phone number displayed in phone 833. Referring briefly to FIG. 1, in one embodiment, communication server 150 routes a telephone call to the phone number associated with mobile device 100. Similarly, actuation of an email button 808 causes routing of an email to the email address displayed in email 834. Referring briefly to FIG. 1, in one embodiment, communication server 150 routes an email to the email address associated with mobile device 100.

As mentioned above, the data fields included in a persistent dashboard, such as persistent dashboard 830, are configurable according to the present invention. A number of response attempts 838 is shown, which allows the agent using agent interface to ascertain the priority of a session that has been routed for live processing. Additionally, thought they are not shown in FIG. 8, an account number, account priority, or other relevant context information can be selected to be displayed in persistent dashboard 830. If a request for live session processing is not sufficiently important for the agent to process the session, the agent can actuate reject button 870, which ends live processing and returns the user to automated processing. Furthermore, customer dashboard 830 may be configured to include, for example, Previous and Next buttons (not shown) to enable scrolling to and from information related to previous activity of the agent using the host application, such as calls that the agent had previously attended to during a session using the host application.

In the example embodiment shown, persistent dashboard 830 is visible as a separate frame below the communications toolbar 810 and screen tabs 820 and above the frame including base view 840. In base view 840, the agent can navigate among various types of application data and/or different screens and view of agent interface 802, while persistent dashboard 830 provides a persistent view of context information related to the application data presented in base view 840. For example, the customer service agent can quickly navigate to information related to the active customer in persistent dashboard 830 by selecting from the combo box 838 of persistent dashboard 830. The list of views to which the agent can navigate is customizable and, for example, may include the following:
Contact—Activities (default)
Contact—Activity Plans
Contact details
Contact—Service Requests
Contact—Agreements
Contact—Entitlements
Contact—Campaigns
Contact—Opportunities.

When a view is selected, one or more records related to the active customer are displayed in base view 840.

In one embodiment of the present invention, automated results returned to a customer are optionally tuned to refine results on the basis of data relating to the customer. During the customer's interaction with the search utility, data is gathered, both from the customer and from a database, which is used to populate persistent dashboard 830 and customer information pane 862. The data gathered to populate persistent dashboard 830 and customer information pane 862 is also used to automated response 879 and search results provided to an agent in knowledge base search window 860.

When live processing is arranged between a customer and an agent, persistent dashboard 830 and customer information pane 862 are populated with the gathered data that is passed in the live session request. A search is also performed, using the data from persistent dashboard 830 and customer information pane 862. Reference list 866 is populated with the results of the search, and an agent can select a reference to be shown in a window as displayed reference 868. The search performed to populate reference list 866 and the references displayed (as well as their manner of display) are configurably altered on the basis of the text messages sent by the customer prior to the initiation of a live processing session and the results sent as solutions to the customer.

The context information displayed in persistent dashboard 830 is changed in response to certain actions, which are referred to herein as changes in context. For example, a change in context can include receiving a communication event such as a live processing session request, obtaining data entered by a customer, focusing on a data record, and selecting a search results record. In one embodiment, actions such as switching to a new screen or view of the agent interface, or viewing a different type of application data, are not considered to trigger changes in context unless accompanied by one of the aforementioned context-changing actions. In one embodiment of the present invention, a new search is performed and references displayed in reference list 866 are updated in response to configurably-selected changes in context. Changing of the view or viewing of a different type of data at base window 840 followed by selection of an update button (not shown) on the persistent dashboard 830 also changes the context of the dashboard.

FIG. 9 is a diagram of a layered architecture in which an embodiment of the present invention be implemented and support the operations depicted in FIG. 1 and FIGS. 3A-7. Application architecture 902 includes user interface objects layer 910, business objects layer 920, and data objects layer 930. User interface objects layer 910 includes one or more user interface object definitions 912. Referring briefly to FIG. 8, an example of a user interface object definition is a view definition for session window 878. Business objects layer 920 includes one or more business object definitions 922. An example of a business object definition is a contact business object definition, which is used to populate persistent dashboard 830 and customer information pane 862 and is used to generate the solution sent in action 1.10 by automated response application 110. Data objects layer 930 includes one or more data object definitions 932. An example of a data object definition is a schema for a database table. Underlying database architecture 904, which is used to store application data, includes a database management system (DBMS) 940 containing knowledge base 170 and application data 130.

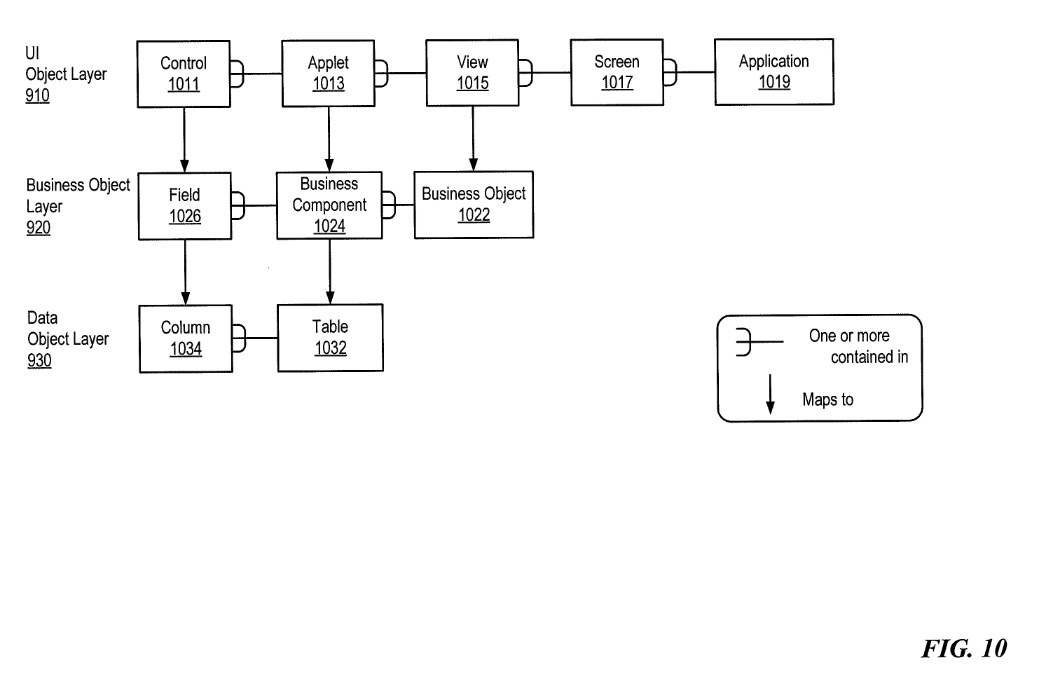

FIG. 10 is a diagram of object layers and object definitions according to the layered architecture of FIG. 9. User interface objects layer 910 includes object definitions application 1019, screen 1017, view 1015, applet 1013, and control 1011. As used herein, application object definition 1019 defines a collection of screens and does not define an application program. Application object definition 1019 includes one or more screens 1017. Each screen 1017 may contain one or more view 1015. View 1015 presents one or more applets 1013 together at one time in a pre-defined visual arrangement and logical data relationship. Each view 1015 may contain one or more applets 1013. In the architecture of the present invention, the term applet is used to describe a form including one or more fields and controls, and is distinguishable from the term applet when used to describe, for example, a Java® program referred to as a Java® applet. Each applet 1013 may include one or more control 1011.

Business objects layer 920 includes business object definition 1022, business component definition 1024, and field object definition 1026. Each business object definition 1022 can include one or more business component object definition 1024. Each business component object definition 1024 may include one or more field object definition 1026.

Data object layer 1030 includes table object definition 1032 and column object definition 1034. Each table object definition 1032 can include one or more column object definition 1034.

As shown in FIG. 10, view object definition 1015 of user interface object layer 910 maps to business object definition 1022 of business objects layer 920. A mapping indicates a one-to-one relationship between objects defined according to the object definitions. For example, a contact view of agent interface 802 displays data for a contact business object.

As noted above, a view may include one or more applets, and a business object may include one or more business components. Accordingly, applets object definition 1013 of user interface object layer 910 maps to business component object definition 1024 of business objects layer 920. A particular applet, or form, of agent interface 802 includes data for a particular business component. Furthermore, a business component, such as business component 1024, maps to an object definition, such as table object definition 1032, of data objects layer 930. Consequently, a particular applet displays data for a particular business component from a particular data table. In at least one embodiment, a “virtual” business component corresponds to a business component for which data are not obtained from a single database table, but instead are the result of a combination of joins with two or more database tables.

Control object definition 1011 of user interface object layer 910 maps to field object definition 1026 of business objects layer 920. A particular control within an applet corresponds to a field object definition. Furthermore, field object definition 1026 maps to column object definition 1034 of data object layer 930. Data for a column of a particular table corresponds to a field of the corresponding business component and is displayed within a control in a corresponding applet.

A communication utility, such as session window 878, can be implemented as a separate frame and view below communication toolbar 810 or, in an alternative embodiment, as part of base view 840. Session window 878 is based on a virtual business component called “text messaging session window ” which lies in the instance of a “text messaging session window ” business object. Examples of object definitions related to a text message session window, such as session window 878, are given below:
Text Messaging Session Window Business Object
Text Messaging Session Window Business Component (virtual business component)
Text Messaging Session Window Business Service (controls the functionality)
Text Messaging Session Window Applet (user interface)
Text Messaging Session Window View (user interface)

In one embodiment of the present invention, when updating session window 878 from communication toolbar 810, a SmartScript response or an application program can use an Updatetextsession application program interface (API) for the Text Messaging Session Window Business Service. The Updatetextsession API can be called using the InvokeMethod function of the Text Messaging Session Window Business Service and passing a set of name/value pairs, such as the following:
Source Name: ‘Base View’
BusComp Name: ‘Updatetextsession’
RowId: ‘latestreceived’
   In one embodiment, the InvokeMethod function of the Text Messaging Session Window Business Service is used to call Updatetextsession API for configurable events. For example, an enterprise may define a customized event for which session window 878 is updated, such as sending of a file to a mobile device, and associate the customized event with a button on an applet within the agent interface.

Upon receiving the arguments, the invoked function of the Text Messaging Session Window Business Service obtains the set of fields configured to be displayed. The involved function then retrieves corresponding data from application data 130, knowledge base 360, and session window 878.

In one embodiment, session window 878 is configurable. For example, various agent interface changes can be made, such as changing the color, size, location, and adding or removing fields from the display window (applet) displaying session window 878.

A session update engine within functional control module 160 is responsible for ensuring that session window 878 is updated whenever communication between mobile unit 100 and either of agent interface 180 or automated response application 110 occurs. In one embodiment, the session update engine is implemented as a session update engine business service. The session update engine business service provides an application program interface (API) that includes a member function to update session window 878 within agent interface 802. Member functions can correspond to a command definition for a command to, for example, push incoming text messages to session window 878. The Updatetextsession API may further include a command definition for a maintain command to maintain the content of session window 878 until a change in context occurs.

The communication administration views can be pre-configured to call InvokeMethod (with Updatetextsession as a parameter) when a communication event is received, such as an incoming chat. Variables are passed as arguments to update session window 878. When InvokeMethod is called with the Updatetextsession parameter, the business service member function UpdatefromCTI obtains the list of fields that are configured to be displayed in session window 878. In an embodiment of the present invention, fields to be displayed in session window 878 will include communications sent by an agent and a user of a mobile unit, as well as communication event announcements stored within the relevant session profile. Data to update session window 878 can be passed as parameters and/or queried from appropriate application. Since the session window 878 is implemented as a business service, a program calling session window 878 may use a GetService (“Textsession”) command. The program may set up a control to either push information to session window 878 or pull information from session window 878.

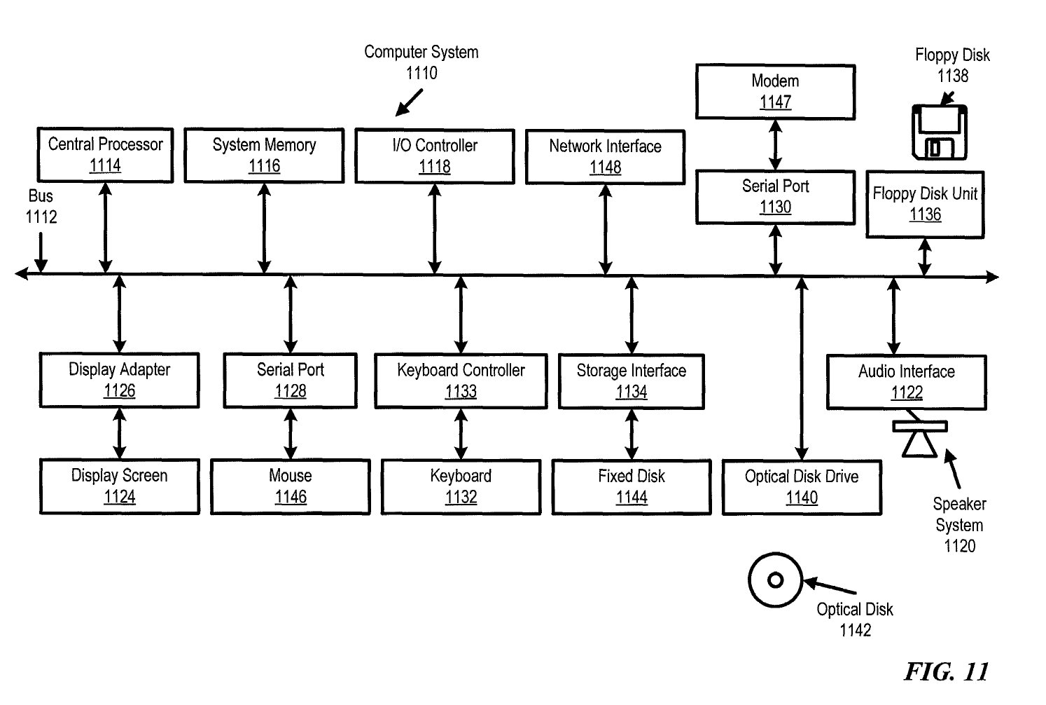

FIG. 11 depicts a block diagram of a computer system 1110 suitable for implementing the present invention as a mobile device, server, or agent station supporting an agent interface. Computer system 1110 includes a bus 1112 which interconnects major subsystems of computer system 1110 such as a central processor 1114, a system memory 1116 (typically RAM, but which may also include ROM, flash RAM, or a similar computer-readable storage medium), an input/output controller 1118, an external audio device such as a speaker system 1120 via an audio output interface 1122, an external device such as a display screen 1124 via display adapter 1126, serial ports 1128 and 1130, a keyboard 1132 (interfaced with a keyboard controller 1133), a storage interface 1134 for interfacing with a computer-readable storage medium such as a floppy disk drive 1136 operative to receive a floppy disk 1138, and a CD-ROM drive 1140 operative to receive a CD-ROM 1142. Also included are a mouse 1146 (or other point-and-click device, coupled to bus 1112 via serial port 1128), a modem 1147 (coupled to bus 1112 via serial (or USB) port 1130) and a network interface 1148 (coupled directly to bus 1112).

Bus 1112 allows data communication between central processor 1114 and system memory 1116, which may include both read only memory (ROM) or flash memory (neither shown), and random access memory (RAM) (not shown), as previously noted. The RAM is generally the main memory into which the operating system and application programs are loaded and typically affords at least 1116 megabytes of memory space. The ROM or flash memory may contain, among other code, the Basic Input-Output system (BIOS) which controls basic hardware operation such as the interaction with peripheral components. Applications resident with computer system 1110 are generally stored on and accessed via a computer readable storage medium, such as a hard disk drive (e.g., fixed disk 1144), an optical drive (e.g., CD-ROM or DVD drive 1140), floppy disk unit 1136 or other storage medium.

Storage interface 1134, as with the other storage interfaces of computer system 1110, may connect to a standard computer readable storage medium for storage and/or retrieval of information, such as a fixed disk drive 1144. Fixed disk drive 1144 may be a part of computer system 1110 or may be separate and accessed through other interface systems. Many other devices can be connected such as a mouse 1146 connected to bus 1112 via serial port 1128, a modem 1147 connected to bus 1112 via serial port 1130 and a network interface 1148 connected directly to bus 1112. Modem 1147 may provide a direct connection to a remote server via a telephone link or to the Internet via an internet service provider (ISP). Network interface 1148 may provide a direct connection to a remote server via a direct network link to the Internet via a POP (point of presence). Network interface 1148 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., bar code readers, document scanners, digital cameras and so on). Conversely, that all of the devices shown in FIG. 11 be present is not necessary to practice the present invention. The devices and subsystems may be interconnected in different ways from that shown in FIG. 11. The operation of a computer system such as that shown in FIG. 11 is readily known in the art and is not discussed in detail in this application. Code to implement the present invention may be stored in computer-readable storage media such as one or more of system memory 1116, fixed disk 1144, CD-ROM 1142, or floppy disk 1138. Additionally, computer system 1110 may be any kind of computing device, and so includes personal data assistants (PDAs), network appliances, mobile phones, X-window terminals or other such computing devices. The operating system provided on computer system 1110 may be MS-WINDOWS®, Mac OS 10®, UNIX®, Linux® or other known operating system. Computer system 1110 also supports a number of Internet access tools, including, for example, an HTTP-compliant web browser having a JavaScript interpreter or similar components.

Moreover, regarding the messages and/or data signals described herein, those skilled in the art will recognize that a signal may be directly transmitted from a first block to a second block, or a signal may be modified (e.g., amplified, attenuated, delayed, latched, buffered, inverted, filtered or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

The foregoing described embodiments include components contained within other components. One skilled in the art will understand, upon having read the present disclosure, that such architectures are merely examples, and that in fact many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

The foregoing detailed description has set forth various embodiments of the present invention via the use of block diagrams, flowcharts, and examples. One skilled in the art will understand, upon having read the present disclosure, that each block diagram component, flowchart step, operation and/or component illustrated by the use of examples can be implemented, individually and/or collectively, by a wide range of hardware, software, firmware, or any combination thereof.

The present invention has been described in the context of fully functional computer and mobile device systems; however, those skilled in the art will appreciate that the present invention is capable of being distributed as a program product in a variety of forms, and that the present invention applies equally regardless of the particular type of media used to actually carry out the distribution. Examples of signal bearing media include recordable media such as floppy disks and CD-ROM, as well as media storage and distribution systems developed in the future.

The above-discussed embodiments may be implemented by software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein.

The above description is intended to be illustrative of the invention and should not be taken to be limiting. Other embodiments within the scope of the present invention are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the invention. Variations and modifications of the embodiments disclosed herein can be made based on the description set forth herein, without departing from the scope of the invention. Consequently, the invention is intended to be limited only by the scope of the appended Claims, giving full cognizance to equivalents in all respects.

What is claimed is:

1. A method, the method comprising:
responsive to receiving a request for support, building a session profile using the request for support, wherein
the request for support is received from a mobile device;
identifying a solution by querying a database, wherein
the querying uses the session profile and the request for support,
the database comprises
a plurality of possible user inquiries, and
a plurality of possible solutions associated with one or more of the plurality of possible user inquiries,
the solution is associated with the request for support, and
the solution is one of the plurality of possible solutions; and
transmitting the solution to the mobile device, wherein
the transmitting further comprises
transmitting a credential to the mobile device,
verifying an eligibility of the mobile device, and
transmitting the solution and program instructions executable on the mobile device.

2. The method of claim 1, wherein the verifying the eligibility of the mobile device further comprises:
querying a subscriber database for eligibility information; and
verifying an eligibility of the mobile device to receive the solution.

3. The method of claim 1, further comprising:
receiving an item of extrinsic data;
adding the item of extrinsic data to the session profile; and
customizing the solution, in response to receiving the item of extrinsic data.

4. The method of claim 3, wherein the extrinsic data is one of:
status data reflecting a status of the mobile device; and
customer data received from a customer information database.

5. The method of claim 1, further comprising
responsive to an indication that the solution is inadequate, adding to the session profile additional information received from the user, wherein
the indication that the solution is inadequate is one of an expression of dissatisfaction from a user, and
a failure notice indicating that an attempted execution of instructions is not successful; and
responsive to a number of solution attempts exceeding a threshold for the number of solution attempts, sending the session profile to an agent, wherein
sending the session profile to the agent results in a live session between the user of the mobile device and the agent.

6. The method of claim 1, further comprising:
re-initiating a session associated with the session profile in response to receiving a second request for support from the mobile device.

7. The method of claim 1, further comprising:
adjusting the threshold in response to content of the session profile.

8. The method of claim 1, further comprising,
requesting the credential, wherein
the credential comprises an encryption key; and
verifying the instructions, wherein
the verifying comprises determining an authentication value from an authentication key.

9. A computer-readable storage medium, said computer-readable storage medium having instructions stored thereon, said instructions comprising:
a first set of instructions for, responsive to receiving a request for support, building a session profile using the request for support, wherein
the request for support is received from a mobile device;
a second set of instructions for identifying a solution by querying a database, wherein
the second set of instructions uses the session profile and the request for support,
the database comprises
a plurality of possible user inquiries, and
a plurality of possible solutions associated with one or more of the plurality of possible user inquiries;
the solution is associated with the request for support, and
the solution is one of the plurality of possible solutions; and
a third set of instructions for transmitting the solution to the mobile device, wherein
the third set of instructions further comprises
a fourth set of instructions for transmitting a credential to the mobile device,
a fifth set of instructions for verifying an eligibility of the mobile device, and
a sixth set of instructions for transmitting the solution and program instructions executable on the mobile device.

10. The computer-readable storage medium of claim 9, wherein the fifth set of instructions further comprises:
a seventh set of instructions for querying a subscriber database for eligibility information; and
an eighth set of instructions for verifying an eligibility of the mobile device to receive the solution.

11. The computer-readable storage medium of claim 9, said instructions further comprising:
a ninth set of instructions for receiving an item of extrinsic data;
a tenth set of instructions for adding the item of extrinsic data to the session profile; and
an eleventh set of instructions for customizing the solution, in response to receiving the item of extrinsic data.

12. The computer-readable storage medium of claim 11, wherein the extrinsic data is one of:
status data reflecting a status of the mobile device; and
customer data received from a customer information database.

13. The computer-readable storage medium of claim 9, said instructions further comprising
a twelfth set of instructions for, responsive to an indication that the solution is inadequate, adding to the session profile additional information received from the user,
wherein
the indication that the solution is inadequate is one of an expression of dissatisfaction from a user, and
a failure notice indicating that an attempted execution of instructions is not successful; and
a thirteenth set of instructions for, responsive to a number of solution attempts exceeding a threshold for the number of solution attempts, sending the session profile to an agent, wherein
sending the session profile to the agent results in a live session between the user of the mobile device and the agent.

14. The computer-readable storage medium of claim 9, said instructions further comprising:
a fourteenth set of instructions for re-initiating a session associated with the session profile in response to receiving a second request for support from the mobile device.

15. The computer-readable storage medium of claim 9, said instructions further comprising:
a fifteenth set of instructions for adjusting the threshold in response to content of the session profile.

16. The computer-readable storage medium of claim 9, said instructions further comprising,
a sixteenth set of instructions for requesting the credential, wherein the credential comprises an encryption key; and
a seventeenth set of instructions for verifying the instructions, wherein the verifying comprises determining an authentication value from an authentication key.

17. An apparatus, comprising
a processor
means for causing said processor to, responsive to receiving a request for support, build a session profile using the request for support, wherein
the request for support is received from a mobile device;
means for causing said processor to identify a solution by querying a database, wherein the querying uses the session profile and the request for support,
the database comprises
a plurality of possible user inquiries, and
a plurality of possible solutions associated with one or more of the plurality of possible user inquiries;
the solution is associated with the request for support, and
the solution is one of the plurality of possible solutions; and
means for causing said processor to transmit the solution to the mobile device, wherein
the means for causing said processor to transmit further comprises
means for causing said processor to transmit a credential to the mobile device,
means for causing said processor to verify an eligibility of the mobile device, and
means for causing said processor to transmit the solution and program instructions executable on the mobile device.

18. The apparatus of claim 17, wherein the means for causing said processor to verify the eligibility of the mobile device further comprises:
means for causing said processor to query a subscriber database for eligibility information; and
means for causing said processor to verify an eligibility of the mobile device to receive the solution.

19. The apparatus of claim 17, further comprising:
means for causing said processor to receive an item of extrinsic data;
means for causing said processor to add the item of extrinsic data to the session profile; and
means for causing said processor to customize the solution, in response to receiving the item of extrinsic data.

20. The apparatus of claim 19, wherein the extrinsic data is one of:
status data reflecting a status of the mobile device; and
customer data received from a customer information database.

21. The apparatus of claim 17, further comprising
means for causing said processor to, responsive to an indication that the solution is inadequate, add to the session profile additional information received from the user, wherein
the indication that the solution is inadequate is one of an expression of dissatisfaction from a user, and
a failure notice indicating that an attempted execution of instructions is not successful; and
means for causing said processor to, responsive to a number of solution attempts exceeding a threshold for the number of solution attempts, send the session profile to an agent, wherein
means for causing said processor to send the session profile to the agent include means for creating a live session between the user of the mobile device and the agent.

22. The apparatus of claim 17, further comprising:
means for causing the processor to re-initiate a session associated with the session profile in response to receiving a second request for support from the mobile device.

23. The apparatus of claim 17, further comprising:
means for causing the processor to adjust the threshold in response to content of the session profile.

24. The apparatus of claim 17, further comprising,
means for causing the processor to request the credential, wherein
the credential comprises an encryption key; and
means for causing the processor to verify the instructions, wherein
the means for causing the processor to verify comprises means for causing the processor to determine an authentication value from an authentication key.
